(19) United States
(12) Patent Application Publication
(10) Pub. No.: US 2015/0108376 A1
(43) Pub. Date: Apr. 23, 2015

(54) Distance Measuring Photoelectric Sensor And Method For Controlling Light Projection Spot Thereof

(71) Applicant: Keyence Corporation, Osaka (JP)

(72) Inventor: Yasunori Kawaguchi, Osaka (JP)

(21) Appl. No.: 14/481,014

(22) Filed: Sep. 9, 2014

(30) Foreign Application Priority Data
Oct. 18, 2013 (JP) 2013-217218

(51) Int. Cl. G02B 27/09; G01C 3/06

(52) U.S. Cl. CPC G02B 27/09; G01C 3/06
USPC 250/559.38

(57) ABSTRACT

Provided is a distance measuring photoelectric sensor capable of freely changing a size of a spot diameter of detection light. A distance measuring photoelectric sensor is configured by: a light emitting element which generates detection light; a light projecting lens which is arranged on an optical axis of the light emitting element and is configured to project the detection light toward a detection region; and an optical path length adjustment mechanism which adjusts an optical path length of the detection light from the light emitting element to the light projecting lens. A size of a spot diameter of the detection light to be used for measurement of the distance is freely selectable by the optical path length adjustment mechanism.

### CROSS-REFERENCE TO RELATED APPLICATIONS

The present application claims foreign priority based on Japanese Patent Application No. 2013-217218, filed Oct. 18, 2013, the contents of which is incorporated herein by reference.

### BACKGROUND OF THE INVENTION

1. Field of the Invention

The present invention relates to a distance measuring photoelectric sensor and a method for controlling a light projection spot thereof, and more specifically, relates to improvement in photoelectric sensor which projects detection light and receives reflected light of the detection light.

2. Description of Related Art

A distance measuring photoelectric sensor projects detection light toward a detection region, receives the detection light reflected from a workpiece in the detection region, and obtains a distance to the workpiece, to generate a determination signal indicating presence or absence of the workpiece. Further, the distance measuring photoelectric sensor displays a distance measured value on a display section, or outputs a determination signal or an analog signal indicating the distance measured value to an external device. For example, a distance to the workpiece is obtained by detecting a one-dimensional light receiving amount distribution by means of an image sensor, using the principle of triangulation. Alternatively, the distance to the workpiece can be obtained by using the TOF (Time Of Flight) method for measuring transmission time of the detection light from the light projection to the light reception. The determination signal is generated based on a comparison result obtained by comparing the distance to the workpiece with a threshold.

In a typical distance measuring photoelectric sensor, a measurement range is defined, and a shape of a light projection beam is designed such that desired performance is satisfied within the measurement range. For example, it is designed such that, even if the distance to the workpiece changes, the spot diameter of the light projection spot is substantially constant, or it is designed such that a beam diameter (spot diameter) is minimal in the vicinity of the center of the measurement range. Particularly, in a photoelectric sensor using the principle of triangulation, there is desired a light projection spot having a small spot diameter with respect to a longitudinal direction of an image sensor.

However, making the beam diameter (spot diameter) small may not necessarily lead to a good result depending on a state of the surface of the workpiece, and this cannot be dealt with by the photoelectric sensor using the principle of triangulation.

Further, it is difficult to previously determine what degree of beam diameter (spot diameter) is favorable only by looking at the state of the surface of the workpiece. For example, when a small workpiece is to be detected through a hole in an obstacle on the front, it is difficult to previously grasp what sort of light projection beam is optimal.

### SUMMARY OF THE INVENTION

The present invention has been made in view of the above circumstances, and an object thereof is to provide a distance measuring photoelectric sensor capable of freely changing a size of a spot diameter of detection light. Particularly, an object thereof is to provide a distance measuring photoelectric sensor capable of freely changing a size of a spot diameter of detection light in a detection region.

Moreover, an object of the present invention is to provide a method for controlling a light projection spot in such a distance measuring photoelectric sensor as described above.

According to one embodiment of the present invention, a distance measuring photoelectric sensor includes: a light emitting element which generates detection light; a light projecting lens which is arranged on an optical axis of the light emitting element and is configured to project the detection light toward a detection region; an optical path length adjustment mechanism which adjusts an optical path length of the detection light from the light emitting element to the light projecting lens; a light receiving element which receives the detection light reflected from a detection target section in the detection region, and generates a light receiving signal; and a distance computing section which measures a distance to the detection target from transmission time of the detection light based on the light receiving signal, wherein a size of a spot diameter of the detection light to be used for measurement of the distance is freely selectable by the optical path length adjustment mechanism.

In this distance measuring photoelectric sensor, by adjusting the optical path length of the detection light from the light emitting element to the light projecting lens, an apparent position of the light emitting element in the case of being seen from the emission side of the light projecting lens moves in a direction of the optical axis, and hence it is possible to freely change the size of the spot diameter of the detection light in the detection region.

In the distance measuring photoelectric sensor according to another embodiment of the present invention, in addition to the above configuration, the optical path length adjustment mechanism selectively arranges an optical path length conversion element having an incident surface and an emitting surface parallel to each other between the light emitting element and the light projecting lens, to adjust the optical path length.

With such a configuration, since a movable mechanism that physically moves the light emitting element or the light projecting lens is not required, displacement of the optical axis between the light emitting element and the light projecting lens hardly occurs. Further, in the case where the detection light passes through the optical path length conversion element which has the incident surface and the emitting surface parallel to each other, even if a position or a direction of the optical path length conversion element is slightly displaced, it has a small influence on the optical path length. Hence, a mechanical load such as a vibration or a change in ambient temperature hardly has an influence, and it is thus possible to accurately control the size of the spot diameter of the detection light.

Further, since the optical path length is adjusted by selectively arranging the optical path length conversion element between the light emitting element and the light projecting lens, it is possible to suppress an increase in size of the distance measuring photoelectric sensor in a direction of a light projection axis. Moreover, since the optical path length conversion element need not be held by a rigid structure, it is possible to suppress an increase in size of the device and a rise in manufacturing cost.

In the distance measuring photoelectric sensor according to still another embodiment of the present invention, in addition to the above configuration, the optical path length adjustment mechanism switches in stages the size of the spot diameter of the detection light to be used for measurement of the distance. With such a configuration, it is possible to improve the reproducibility at the time of adjusting the spot diameter as compared to the case where the spot diameter is continuously switched.

According to still another embodiment of the present invention, in addition to the above configuration, the distance measuring photoelectric sensor includes a determination signal generation section which compares the distance with a previously set threshold, and generates a determination signal based on a result of the comparison. In this distance measuring photoelectric sensor, a determination signal in accordance with the presence or absence of the detection target can be outputted to the external device.

According to still another embodiment of the present invention, in addition to the above configuration, the distance measuring photoelectric sensor includes two or more of the optical path length conversion elements each having a different distance between the incident surface and the emitting surface from each other, wherein the optical path length adjustment mechanism selectively arranges any one of the optical path length conversion elements on the optical axis of the light emitting element.

The optical path length from the incident surface to the emitting surface of the optical path length conversion element is proportional to a distance between the incident surface and the emitting surface. In the above distance measuring photoelectric sensor, any one of the two or more optical path length conversion elements each having a different distance between the incident surface and the emitting surface from each other is selectively arranged on the optical axis of the light emitting element, and hence it is possible to adjust the optical path length from the light emitting element to the light projecting lens within a previously set range.

According to still another embodiment of the present invention, in addition to the above configuration, the distance measuring photoelectric sensor includes two or more of the optical path length conversion elements which are made of transparent members each having a different refractive index from each other, wherein the optical path length adjustment mechanism selectively arranges any one of the optical path length conversion elements on the optical axis of the light emitting element.

The optical path length from the incident surface to the emitting surface of the optical path length conversion element is proportional to a refractive index of a transparent member. In the above distance measuring photoelectric sensor, any one of the two or more of the optical path length conversion elements each having a different refractive index from each other is selectively arranged on the optical axis of the light emitting element, and hence it is possible to adjust the optical path length from the light emitting element to the light projecting lens within a previously set range.

According to still another embodiment of the present invention, in addition to the above configuration, the distance measuring photoelectric sensor includes a conversion element holder which holds two or more of the optical path length conversion elements in different positions in a circumferential direction around a rotating shaft, wherein the optical path length adjustment mechanism selects a rotating angle of the conversion element holder around the rotating shaft, to arrange any one of the optical path length conversion elements on the optical axis of the light emitting element. With such a configuration, by rotating the conversion element holder around the rotating shaft, it is possible to adjust the optical path length from the light emitting element to the light projecting lens within a previously set range.

In the distance measuring photoelectric sensor according to still another embodiment of the present invention, in addition to the above configuration, the conversion element holder has a rotating shaft which is substantially parallel to the optical axis of the light emitting element. With such a configuration, the conversion element holder is rotated around the rotating shaft which is substantially parallel to the optical axis of the light emitting element, and hence it is possible to suppress an increase in size of the distance measuring photoelectric sensor in the direction of the light projection axis.

According to still another embodiment of the present invention, there is provided a method for controlling a light projection spot of a distance measuring photoelectric sensor which projects detection light toward a detection region and receives the detection light reflected from a detection target in the detection region, wherein an optical path length conversion element which has an incident surface and an emitting surface parallel to each other is selectively arranged on an optical path of the detection light from a light emitting element which generates the detection light to a light projecting lens, to adjust a length of the optical path.

According to the present invention, it is possible to provide a distance measuring photoelectric sensor capable of freely changing a size of a spot diameter of detection light. Particularly, in the distance measuring photoelectric sensor according to the present invention, it is possible to freely change the size of the spot diameter of detection light in a detection region.

Moreover, according to the present invention, it is possible to provide a method for controlling a light projection spot in the distance measuring photoelectric sensor as described above.

### BRIEF DESCRIPTION OF THE DRAWINGS

FIGS. 1A and 1B are external views showing one configuration example of a distance measuring photoelectric sensor 1 according to a first embodiment of the present invention;

FIG. 2 is a block diagram showing one example of a functional configuration of the distance measuring photoelectric sensor 1 in FIGS. 1A and 1B;

FIG. 3 is a view showing a configuration example of a conversion element holder 12 in FIG. 2, showing a case where the conversion element holder 12 is seen from a light projecting lens 13 side;

FIGS. 4A and 4B are views showing, as a comparative example, operations of a photoelectric sensor HR that moves a light emitting element 11 in a direction of an optical axis to change a spot diameter of detection light L1;

FIGS. 5A and 5B are views showing one example of an operation of the distance measuring photoelectric sensor 1 in FIG. 2, showing a case where an optical path length conversion element 12a is selectively arranged to change the spot diameter of the detection light L1;

FIG. 6 is a perspective view showing the distance measuring photoelectric sensor 1 in FIGS. 1A and 1B in an exploded manner;

FIGS. 7A and 7B are perspective views showing a configuration example of an optical path length adjustment mechanism 30 in FIG. 6;

FIGS. 8A and 8B are views showing the optical path length adjustment mechanism 30 and an optical base 50;

FIG. 9 is a cross-sectional view showing a configuration example of the optical base 50 in FIGS. 8A and 8B, showing a section in the case where the optical base 50 is cut along a cutting line A1-A1;

FIG. 10 is a diagram showing one example of the operation of the distance measuring photoelectric sensor 1 in FIG. 2, showing a state where a spot diameter distribution changes by adjusting the optical path length of the detection light L1;

FIG. 11 is a view showing a configuration example of the distance measuring photoelectric sensor 1 in FIGS. 1A and 1B, showing a light projecting/receiving surface of a body case 40;

FIG. 12 is a cross-sectional view showing a configuration example of the distance measuring photoelectric sensor 1 in FIG. 11, showing a section in the case where the body case 40 is cut along a cutting line A2-A2;

FIG. 13 is a perspective view showing one configuration example of the distance measuring photoelectric sensor 1 according to a second embodiment of the present invention;

FIG. 14 is a view showing another configuration example of the distance measuring photoelectric sensor 1 in FIG. 2, showing a conversion element holder 12 capable of selecting a region without an optical path length conversion element 12a;

FIG. 15 is a perspective view showing another configuration example of the distance measuring photoelectric sensor 1, showing the conversion element holder 12 that is linearly moved in a direction intersecting with an optical axis KJ;

FIGS. 16A to 16C are views showing another configuration example of the distance measuring photoelectric sensor 1, showing the optical path length conversion element 12a in which a distance between an incident surface and an emitting surface changes in stages in accordance with a rotating angle;

FIGS. 17A to 17C are views showing another configuration example of the distance measuring photoelectric sensor 1, showing the optical path length conversion element 12a in which a distance between the incident surface and the emitting surface changes continuously in accordance with a rotating angle; and

FIG. 18 is a view showing another configuration example of the distance measuring photoelectric sensor 1, showing the optical path length conversion element 12a made of two wedge-shaped optical members 12d.

### DETAILED DESCRIPTION OF PREFERRED EMBODIMENT

### First Embodiment

### <Distance Measuring Photoelectric Sensor 1>

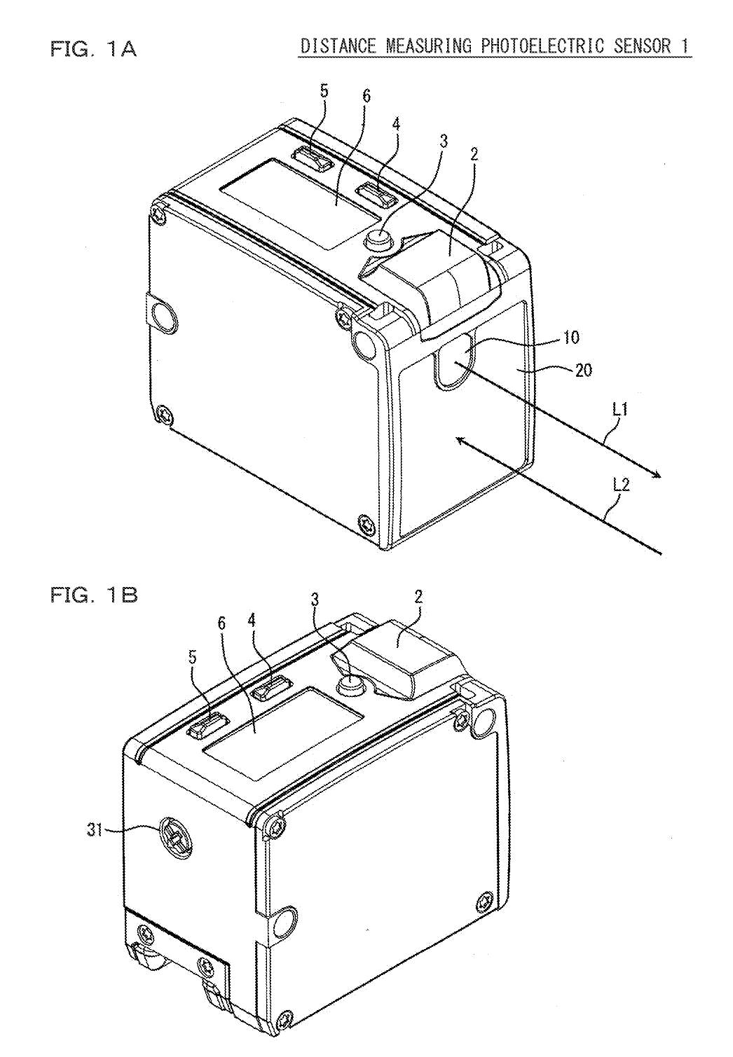

FIG. 1 is an external view showing one configuration example of a distance measuring photoelectric sensor 1 according to a first embodiment of the present invention. FIG. 1A shows a case where the distance measuring photoelectric sensor 1 is seen from diagonally forward, and FIG. 1B shows a case where the distance measuring photoelectric sensor 1 is seen from diagonally backward. This distance measuring photoelectric sensor 1 is a detection switch that applies detection light L1 to a detection target and receives reflected light L2 from the detection target, to generate a determination signal indicating presence or absence of the detection target. For example, the distance measuring photoelectric sensor 1 is a distance measuring photoelectric sensor that obtains a distance to the detection target from a result of the light reception, to generate the determination signal. Further, visible light is used as the detection light L1.

The distance measuring photoelectric sensor 1 includes a light projecting window 10 for projecting the detection light L1 toward the detection target, a light receiving window 20 for receiving reflected light L2 by the detection target, an indicating lamp 2, a set key 3, select keys 4, 5, a screen display section 6, and a trimmer operation section 31. The light projecting window 10 and the light receiving window 20 are disposed on a front surface of a casing. The indicating lamp 2, the set key 3, the select keys 4, 5, and the screen display section 6 are disposed on a top surface of the casing.

The indicating lamp 2 is a display device that indicates the presence or absence of the detection target, a light receiving state, or the like by means of a luminescent color, a lighting state, or the like. The set key 3 and the select keys 4, 5 are operation keys for a variety of inputs and screen switching, and are each made of a press-type contact switch. The screen display section 6 is a display device for displaying a distance measured value, a determination threshold, and the like on a screen.

In this distance measuring photoelectric sensor 1, using an optical path length conversion element having the incident surface and the emitting surface parallel to each other, an optical path length of the detection light L1 from the light emitting element to the light projecting lens is adjusted, and hence it is possible to freely change a size of a spot diameter of a light projection spot formed on the detection target when the detection target is irradiated with the detection light L1. The trimmer operation section 31 is an operation element for adjusting the optical path length, and is disposed on a rear surface of the casing.

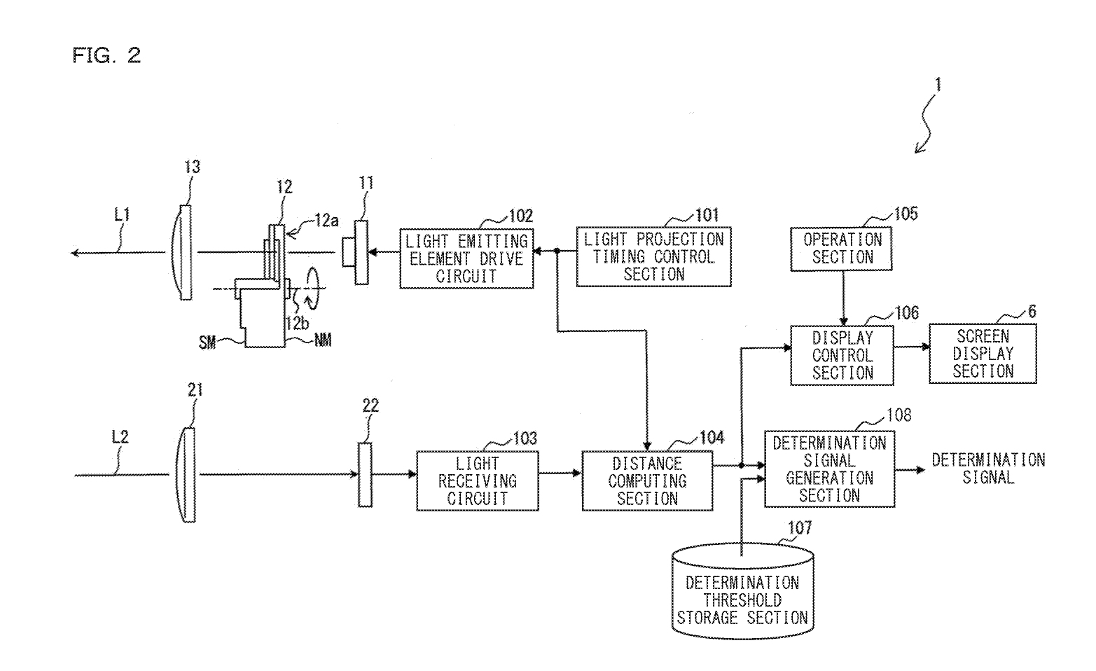

FIG. 2 is a block diagram showing one example of a functional configuration of the distance measuring photoelectric sensor 1 in FIG. 1. This distance measuring photoelectric sensor 1 is configured by the screen display section 6, a light emitting element 11, a conversion element holder 12, a light projecting lens 13, a light receiving lens 21, a light receiving element 22, a light projection timing control section 101, a light reception element drive circuit 102, a light receiving circuit 103, a distance computing section 104, an operation section 105, a display control section 106, a determination threshold storage section 107, and a determination signal generation section 108. FIG. 2 shows a functional configuration of the distance measuring photoelectric sensor 1 that obtains a distance to the detection target by using the TOF method.

The light emitting element 11 is a light source device that generates the detection light L1. For example, a LD (Laser Diode) that generates red laser light is used for the light emitting element 11. The light projecting lens 13 is arranged on an optical axis of the light emitting element 11 and made of one or two or more light projecting lens for projecting the detection light L1 toward a predetermined detection region, and collects or diffuses the detection light L1 from the light emitting element 11.

The conversion element holder 12 is a holding part that holds two or more optical path length conversion elements 12a each having a different distance between an incident surface NM and an emitting surface SM from each other, and is arranged between the light emitting element 11 and the light projecting lens 13. The optical path length conversion element 12a is an optical element that has the incident surface NM and the emitting surface SM parallel to each other, and makes a length of the optical path from the incident surface NM to the emitting surface SM larger than that in the case where the optical path length conversion element 12a is not provided.

This conversion element holder 12 has a rotating shaft 12b substantially parallel to the optical axis of the light emitting element 11, and can be rotated around the rotating shaft 12b. Further, by selecting a rotating angle of the conversion element holder 12, any one of the optical path length conversion elements 12a is arranged on the optical axis of the light emitting element 11, and an optical path length of the detection light L1 from the light emitting element 11 to the light projecting lens 13 is adjusted.

The light receiving lens 21 is made of one or two or more optical lenses that collect the reflected light L2 from the detection target and form an image on the light receiving element 22. The light receiving element 22 is a photoelectric conversion element that receives the reflected light L2 from the detection target and generates a light receiving signal in accordance with a light amount of the reflected light L2, and is arranged on the optical axis of the light receiving lens 21. The reflected light L2 is the detection light L1 reflected by the detection target in the detection region. For example, the light receiving element 22 is made of a PD (Photo Diode), and generates a light receiving signal with a current value changing in accordance with light receiving intensity.

The light projection timing control section 101 generates a timing signal for controlling light projection timing, and outputs the timing signal to the light reception element drive circuit 102 and the distance computing section 104. The light reception element drive circuit 102 lights the light emitting element 11 based on the timing signal.

The light receiving circuit 103 binarizes a light receiving signal from the light receiving element 22 by use of a comparator while differentially amplifying the light receiving signal, and outputs the light receiving signal to the distance computing section 104. The distance computing section 104 samples the binarized light receiving signal to acquire a light receiving waveform, and measures a distance to the detection target based on the light receiving waveform. Specifically, rising of a light receiving pulse corresponding to a light projecting pulse is detected, and based on a speed of the light and transmission time from emission of the detection light L1 from the light projecting window 10 to reception of the reflected light L2 thereof by the light receiving window 20, a distance from the light projecting window 10 to the detection target is obtained.

Based on the distance measured value obtained by the distance computing section 104, the determination signal generation section 108 generates a determination signal indicating the presence or absence of the detection target. The determination signal is generated based on a result of comparison between the distance measured value and the determination threshold. The determination threshold storage section 107 holds a previously set determination threshold. The display control section 106 controls the screen display section 6 based on an input signal from the operation section 105, and displays the distance measured value and the determination threshold. Note that the distance measuring photoelectric sensor 1 may include, in place of the determination signal generation section 108 which generates a determination signal, an analog signal generation section which generates an analog signal indicating a distance measured value. Alternatively, the distance measuring photoelectric sensor 1 may include, in addition to the determination signal generation section 108 which generates a determination signal, the analog signal generation section which generates an analog signal indicating a distance measured value. The determination signal and the analog signal are outputted to the external device.

### <Conversion Element Holder 12>

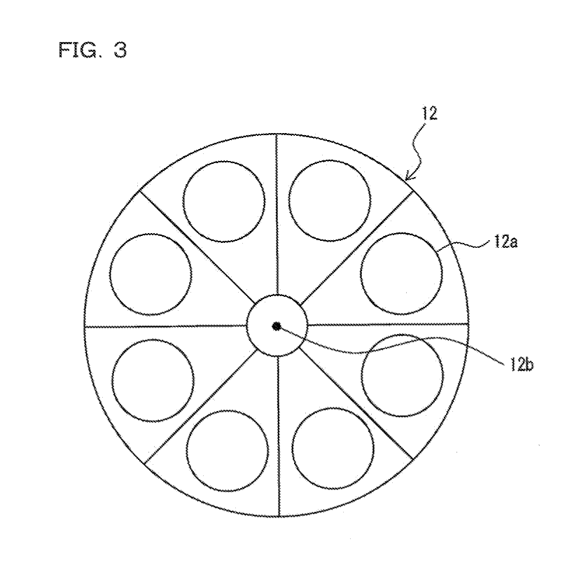

FIG. 3 is a view showing a configuration example of the conversion element holder 12 in FIG. 2, showing a case where the conversion element holder 12 is seen from the light projecting lens 13 side. This conversion element holder 12 is a holder that holds a plurality of optical path length conversion elements 12a in different positions in a circumferential direction around the rotating shaft 12b, and has a shape formed by changing its thickness into a spiral staircase shape.

Further, the incident surface NM of the conversion element holder 12 is substantially vertical to the optical axis of the light emitting element 11, and is made of a flat surface. Each optical path length conversion element 12a is arranged in a fan-shaped region around the rotating shaft 12b, and its thickness in the fan-shaped region is changed in stages, to thereby make the distance between the incident surface NM and the emitting surface SM different among the optical path length conversion elements 12a. In this example, eight optical path length conversion elements 12a are arranged at regular intervals, and the optical path length from the light emitting element 11 to the light projecting lens 13 can be adjusted in eight stages.

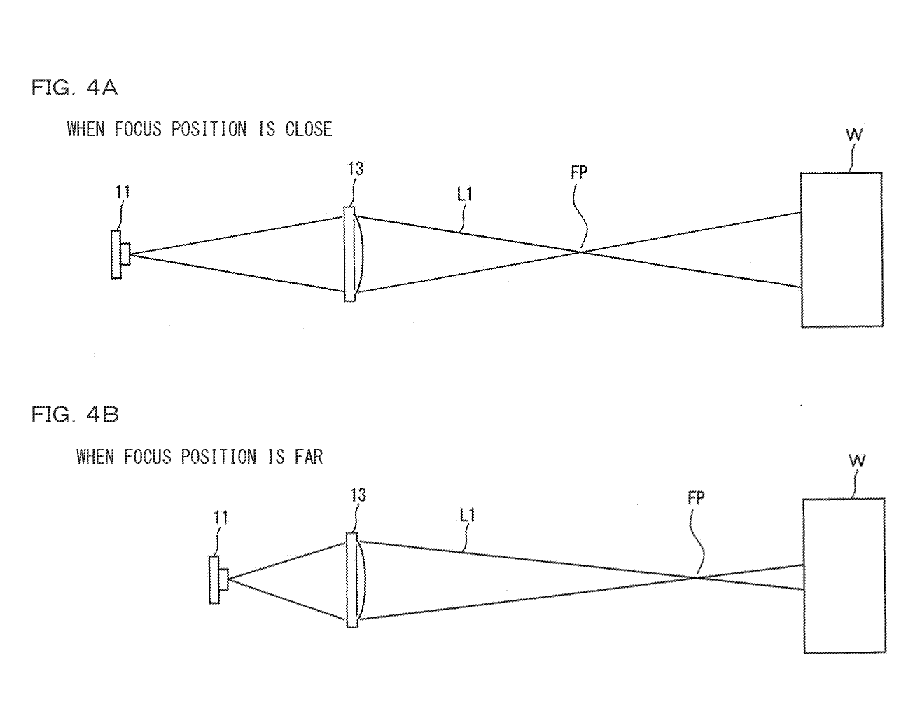

FIGS. 4A and 4B are views showing, as a comparative example, an operation of a photoelectric sensor HR that moves the light emitting element 11 in a direction of the optical axis and changes a distance between the light emitting element 11 and the light projecting lens 13, to change the size of the spot diameter of the detection light L1. FIG. 4A shows a case where a focus position FP is formed at a position close to the light projecting lens 13, and FIG. 4B shows a case where the focus position FP is formed at a position far from the light projecting lens 13.

The detection light L1 emitted from the light emitting element 11 and collected by the light projecting lens 13 has a minimal beam diameter at the focus position FP, and forms a light projection spot on a workpiece W (FIG. 4A). The workpiece W is the detection target. When the light emitting element 11 is brought closer to the light projecting lens 13 from the state of FIG. 4A to reduce the distance between the light emitting element 11 and the light projecting lens 13, the focus position FP of the detection light L1 moves to a position farther from the light projecting lens 13, and the light projection spot on the workpiece W becomes smaller (FIG. 4B). The distance between the light emitting element 11 and the light projecting lens 13 can be continuously changed.

According to such a photoelectric sensor HR, by moving the light emitting element 11 or the light projecting lens 13 in the direction of the optical axis to change the distance between the light emitting element 11 and the light projecting lens 13, it is possible to control the size of the light projection spot and the focus position FP of the detection light L1. However, in the photoelectric sensor HR, since the movable mechanism that physically moves the light emitting element 11 or the light projecting lens 13 is required, displacement of the distance and displacement of the optical axis tend to occur between the light emitting element 11 and the light projecting lens 13 due to looseness of the movable mechanism.

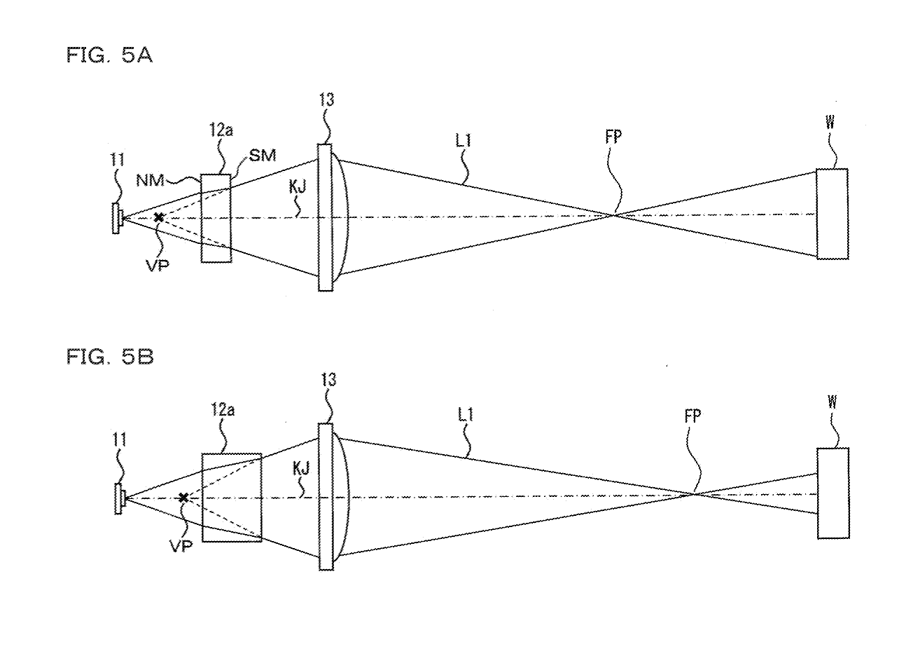

FIGS. 5A and 5B are views showing one example of an operation of the distance measuring photoelectric sensor 1 in FIG. 2, showing a case where any one of the optical path length conversion elements 12a is selectively arranged on an optical axis KJ of the light emitting element 11 to change the size of the spot diameter of the detection light L1. FIG. 5A shows the case where the optical path length conversion element 12a with a small thickness is arranged on the optical axis KJ, and FIG. 5B shows the case where the optical path length conversion element 12a with a large thickness is arranged on the optical axis KJ.

In the case of the photoelectric sensor HR, as the detection light L1 emitted from the light emitting element 11 gets closer to the light projecting lens 13, its beam diameter increases with a constant inclination. In contrast, in the distance measuring photoelectric sensor 1, the detection light L1 emitted from the light emitting element 11 is transmitted through the optical path length conversion element 12a and is incident on the light projecting lens 13. A light transmitting region of the optical path length conversion element 12a has a shape and a size to cover an optical path of the detection light L1.

Generally, the optical path length from the incident surface NM to the emitting surface SM is an optical distance represented by the product of a refractive index n of a transparent member constituting the optical path length conversion element 12a and a distance (physical distance) between the incident surface NM and the emitting surface SM, namely, a thickness D of the transparent member. With the refractive index n being larger than 1, arranging the optical path length conversion element 12a on the optical axis KJ can make the optical path length from the light emitting element 11 to the light projecting lens 13 larger as compared to the case where the optical path length conversion element 12a is not provided. That is, an apparent light emitting position of the light emitting element 11 can be brought closer to the light projecting lens 13 side.

Alternatively, arranging the optical path length conversion element 12a with a large thickness D on the optical axis KJ can make the optical path length from the light emitting element 11 to the light projecting lens 13 larger as compared to the case where the optical path length conversion element 12a with a small thickness D is arranged.

When diffused light whose beam diameter spreads with the optical axis KJ as the center passes through a parallel plate made of a transparent member, beam spread angles in the front and the back of the parallel plate are the same, while a beam spread angle in the parallel plate is slightly smaller. For this reason, a virtual position VP of the light source in the case of being seen from the emission side of the light projecting lens 13, namely, an apparent position of the light emitting element 11, is formed in a position closer to the light projecting lens 13 than an actual position of the light emitting element 11. The virtual position VP of the light source is formed in a position closer to the light projecting lens 13 as the thickness D of the transparent member increases.

In the distance measuring photoelectric sensor 1, by use of the above mechanism, it is possible to control the spread of the detection light L1 transmitted through the light projecting lens 13 without changing the distance between the light emitting element 11 and the light projecting lens 13. In particular, by selectively arranging any one of the optical path length conversion elements 12a each having a different thickness D on the optical axis KJ, it is possible to adjust the spot diameter of the light projection spot in stages.

Further, even if the position of the optical path length conversion element 12a changes or the optical path length conversion element 12a is inclined with respect to the optical axis KJ, it has a small influence on the size of the light projection spot and the focus position of the detection light L1. For this reason, the positioning accuracy of the optical path length conversion element 12a may be relatively low as compared to that of the light emitting element 11 and the light projecting lens 13.

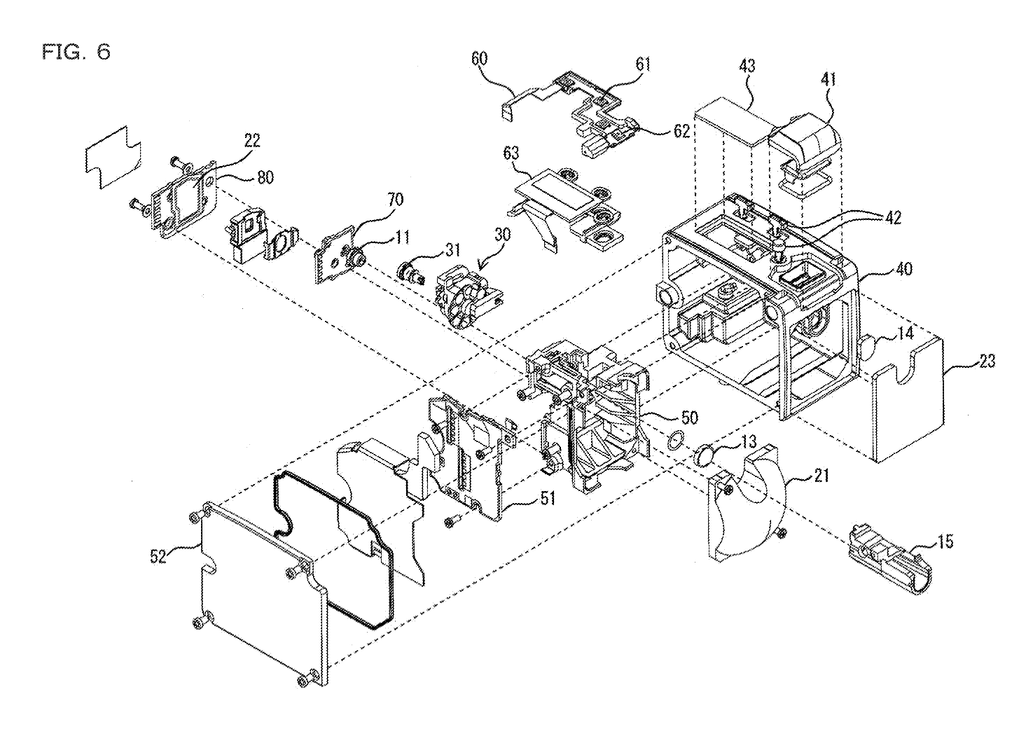

FIG. 6 is a perspective view showing the distance measuring photoelectric sensor 1 in FIGS. 1A and 1B in an exploded manner. In FIG. 6, a direction parallel to the light projection axis of the detection light L1 is taken as a longitudinal direction and referred to as a z-direction, and in a plane vertical to the light projection axis, a horizontal direction is referred to as an x-direction and a vertical direction is referred to as a y-direction.

The distance measuring photoelectric sensor 1 is configured by the light emitting element 11, the light projecting lens 13, a light projecting lens cover 14, a lens barrel 15, a light receiving lens 21, a light receiving element 22, a light receiving lens cover 23, an optical path length adjustment mechanism 30, the trimmer operation section 31, a body case 40, an indicating lamp cover 41, a key top 42, a screen cover 43, an optical base 50, a main substrate 51, a body cover 52, a display substrate 60, a switch contact section 61, display elements 62, 63, a light projecting substrate 70, and a light receiving substrate 80.

### <Optical Base 50>

The optical base 50 is a base member for holding the optical member, and is made of a structure having a shape for ensuring its strength. The optical base 50 is mounted with the optical path length adjustment mechanism 30, the light emitting element 11, the light projecting lens 13, the lens barrel 15, the light receiving lens 21, the light receiving element 22, the main substrate 51, the light projecting substrate 70, and the light receiving substrate 80. This optical base 50 is made of a high-strength resin material, for example, a resin material strengthened by a glass fiber.

The optical path length adjustment mechanism 30 is an optical path length adjustment part that is made of an assembly including the conversion element holder 12, and selectively arranges the optical path length conversion element 12a between the light emitting element 11 and the light projecting lens 13, to thereby adjust the optical path length of the detection light L1 from the light emitting element 11 to the light projecting lens 13. This optical path length adjustment mechanism 30 rotatably supports the conversion element holder 12 around the rotating shaft 12b, and is mounted with the trimmer operation section 31 via the body case 40. The trimmer operation section 31 is made of an operation element for adjusting the optical path length by rotating the conversion element holder 12.

The lens barrel 15 is an optical member that prevents the detection light L1 from the light emitting element 11 from going around the light receiving element 22 inside the distance measuring photoelectric sensor 1. The light projecting lens cover 14 is an optical member for protecting the light projecting lens 13, and is made of a transparent material, for example, an acrylic resin material. The light projecting lens 13 is made of optical glass.

The light receiving lens cover 23 is an optical member for protecting the light receiving lens 21, and is made of a transparent material, for example, an acrylic resin material similar to that for the light projecting lens cover 14. The light receiving lens 21 is made of a transparent material, for example, a transparent resin material.

The light projecting substrate 70 is a wiring substrate with the light emitting element 11 disposed on its front surface. The light receiving substrate 80 is a wiring substrate provided with the light receiving element 22. The main substrate 51 is a circuit substrate disposed with a control circuit that performs main control such as light projecting/receiving control.

The lens barrel 15, the light projecting lens 13, and the light receiving lens 21 are mounted to a front portion of the optical base 50. The optical path length adjustment mechanism 30, the light projecting substrate 70, and the light receiving substrate 80 are mounted to a rear portion of the optical base 50. The main substrate 51 is mounted to a left-side portion of the optical base 50.

### <Body Case 40>

The body case 40 is a parallelepiped⁻shaped casing member that has an internal space for accommodating the optical base 50, the display substrate 60, and the display element 63, and is mounted with the light projecting lens cover 14, the light receiving lens cover 23, the indicating lamp cover 41, the screen cover 43, and the body cover 52. This body case 40 is made of a high-strength high-rigidity metal material, for example, a zinc alloy, and its front surface is a light projecting/receiving surface.

The display element 63 is a display device that has a rectangular-shaped display screen formed on the wiring substrate, and displays the distance measured value and the determination threshold. For example, an OLED (Organic Light-Emitting Diode) with its light emitting layer made of an organic compound is used for the display element 63. The switch contact section 61 is made of a surface-mounted type electric contact that is conducted by pushing force by the key top 42. The display element 62 is a display device for displaying the presence or absence of the detection target and the light receiving state. The display substrate 60 is a wiring substrate on which three switch contact sections 61 and the display element 62 are disposed, and is made of a flexible substrate.

The optical base 50 is accommodated in the body case 40 and screwed onto the body case 40. The display substrate 60 and the display element 63 are accommodated in the body case 40 such that a display screen is exposed via a screen opening provided on the top surface of the body case 40 and the display element 62 is exposed via an indicating lamp opening.

The light projecting lens cover 14 and the light receiving lens cover 23 are mounted to the body case 40 so as to respectively cover the openings on the front surface of the body case 40. The indicating lamp cover 41 is mounted to the body case 40 so as to cover the indicating lamp opening. The screen cover 43 is mounted to the body case 40 so as to cover the screen opening. The body cover 52 is a cover member for blocking an opening on the left-side surface of the body case 40, and is screwed onto the body case 40.

### <Optical Path Length Adjustment Mechanism 30>

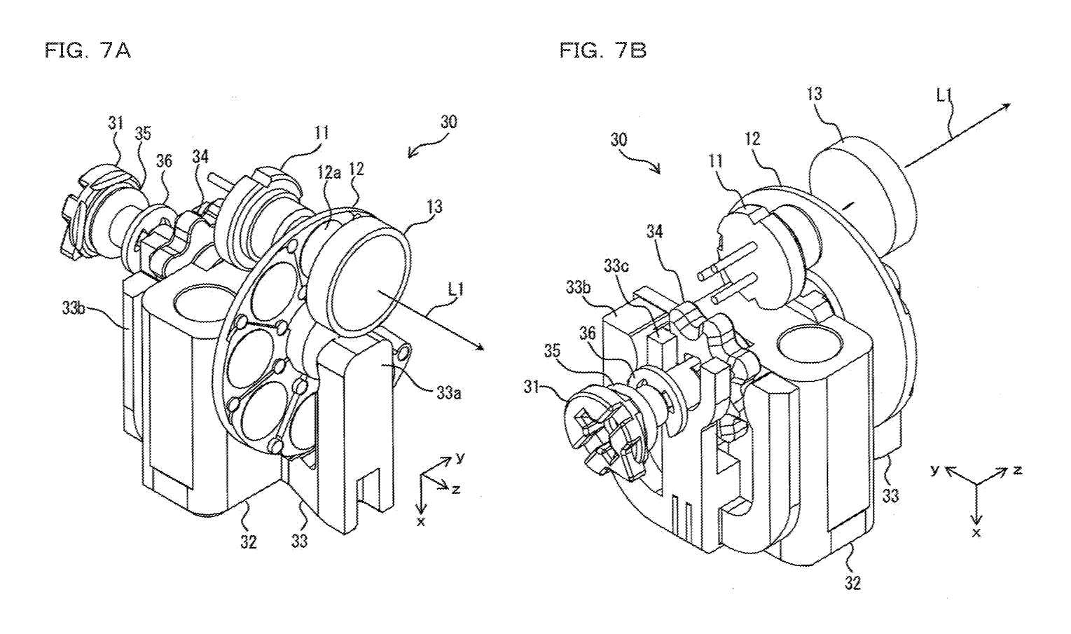

FIGS. 7A and 7B are perspective views showing a configuration example of the optical path length adjustment mechanism 30 in FIG. 6. FIG. 7A shows a case where the optical path length adjustment mechanism 30 is seen from diagonally forward, and FIG. 7B shows a case where the optical path length adjustment mechanism 30 is seen from diagonally backward.

This optical path length adjustment mechanism 30 is configured by the conversion element holder 12, the trimmer operation section 31, a base member 32, a rotating shaft support member 33, a coupling member 34, a sealing member 35, and a retaining member 36. Further, the optical path length adjustment mechanism 30 selects a rotating angle of the conversion element holder 12 around the rotating shaft 12b, to thereby arrange any one of the optical path length conversion elements 12a on the optical axis KJ of the light emitting element 11.

The conversion element holder 12 having the rotating shaft 12b in the z-direction is integrally provided with the plurality of optical path length conversion elements 12a arranged in positions different from each other in the circumferential direction around the rotating shaft 12b, by use of a transparent material, for example, a transparent resin material. This conversion element holder 12 is made of a cylindrical body provided with steps in a spiral staircase shape on its end surface on the light projecting lens side. Further, a reflection suppressing film for suppressing reflection is formed on each of the incident surface NM and the emitting surface SM of the optical path length conversion element 12a.

The rotating shaft support member 33 has an arm section 33a for supporting the conversion element holder 12 on its axis, an engagement section 33b engaged with the coupling member 34, and an arm section 33c for press-holding the coupling member 34 in the z-direction, and the rotating shaft support member 33 is fixed to the base member 32.

The arm section 33a has a shape extending in the x-direction. The conversion element holder 12 is rotatably supported by the arm section 33a and the base member 32 around the rotating shaft 12b. The trimmer operation section 31 and the coupling member 34 are arranged on the same axis as the rotating shaft 12b.

The coupling member 34 is a shaft member that couples the trimmer operation section 31 with the conversion element holder 12, and transmits rotational force from the trimmer operation section 31 to the conversion element holder 12. This coupling member 34 includes a flange section having a circumferential surface with irregularities in the circumferential direction, and a shaft section extending in the direction of the rotating shaft 12b, namely, the z-direction. The shaft section is coupled to the conversion element holder 12 via the base member 32. By engagement of the engagement section 33b with the flange section, the rotating angle of the conversion element holder 12 around the rotating shaft 12b is selected in stages.

The trimmer operation section 31 includes a pedestal head engaged with a tool such as a screwdriver, and a shaft section extending in the z-direction. The tip of the shaft section is coupled to the coupling member 34, and the shaft section is rotatably supported by the arm section 33a. The trimmer operation section 31 and the coupling member 34 are coupled by a predetermined shaft joint mechanism, for example, a joint mechanism of fitting a key and a key groove with each other to transmit power.

Rotating the trimmer operation section 31 only by a predetermined rotating angle by use of a tool such as a screwdriver allows a change in spot diameter of the light projection spot. For example, the spot diameter can be made larger by rotating the trimmer operation section 31 to the left, and the spot diameter can be made smaller by rotating the trimmer operation section 31 to the right. Since the size of the spot diameter can be switched in stages, the reproducibility at the time of adjusting the spot diameter can be improved and an error by the user hardly occurs as compared to the case where the spot diameter is continuously switched.

The sealing member 35 is a gasket for the trimmer operation section 31, and is made of a ring-shaped elastic member, for example, a fluorine rubber member, through which the shaft section of the trimmer operation section 31 is inserted. The retaining member 36 is a locking member for preventing the trimmer operation section 31 from falling out of the body case 40, and is engaged to the shaft section of the trimmer operation section 31.

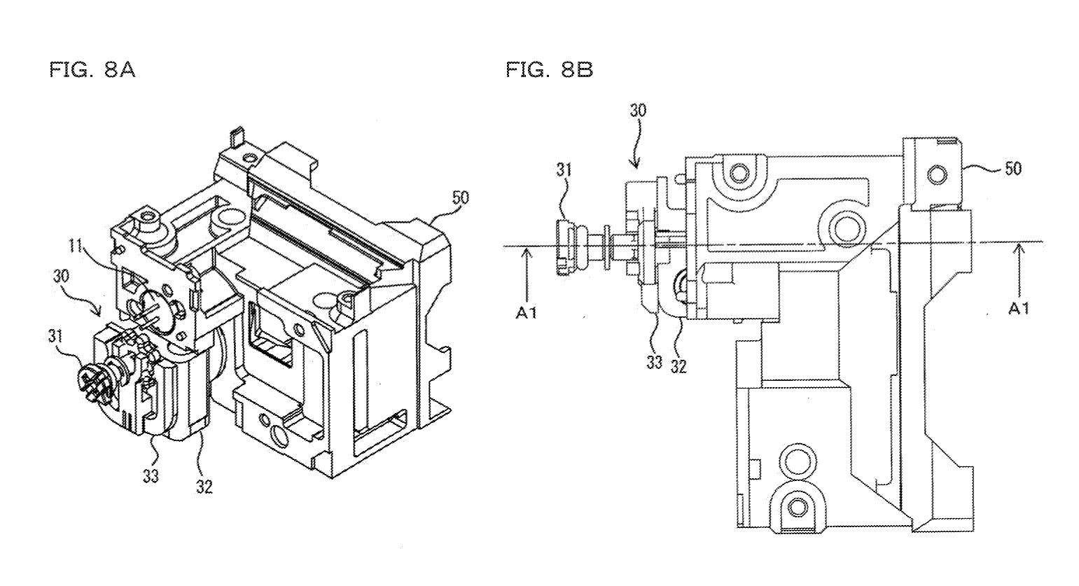

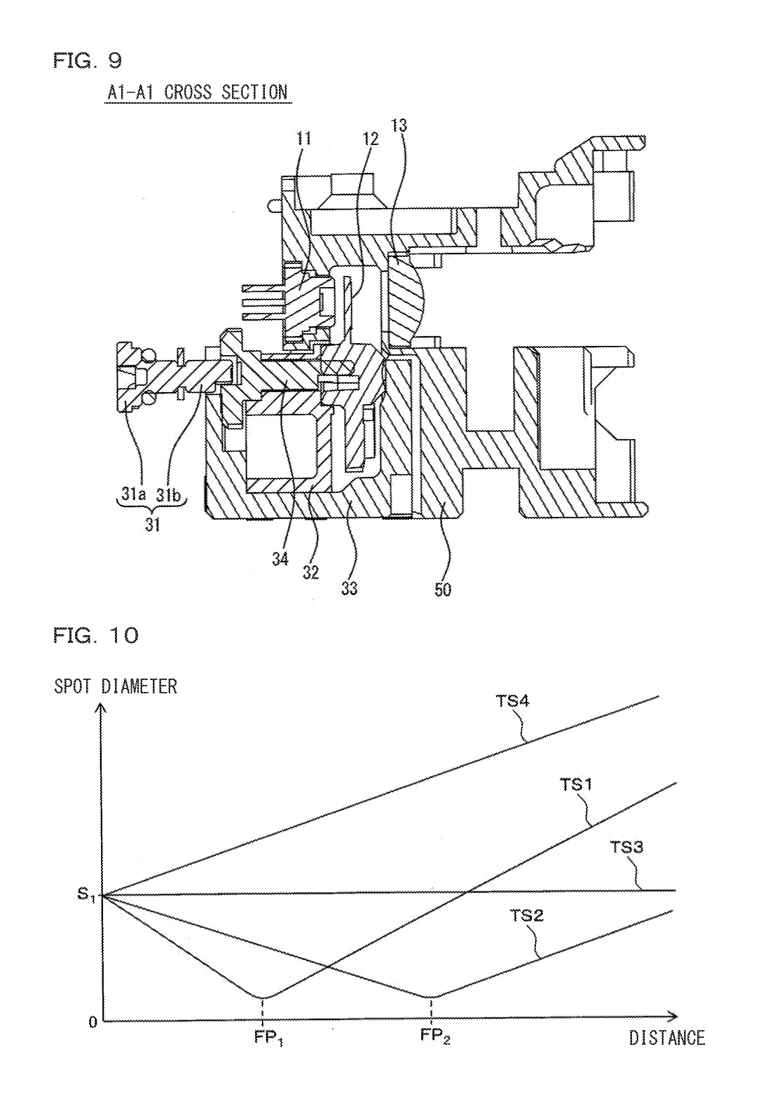

FIGS. 8A and 8B are views showing the optical path length adjustment mechanism 30 and the optical base 50. FIG. 8A shows a perspective view of the optical base 50 seen from diagonally backward, and FIG. 8B shows a case where the optical base 50 is seen from above. Further, FIG. 9 is a cross-sectional view showing a configuration example of the optical base 50 in FIGS. 8A and 8B, showing a section in the case where the optical base 50 is cut along a cutting line A1-A1.

The light emitting element 11 and the light projecting lens 13 are fixed to the optical base 50 with the optical axes thereof matched. Since the light emitting element 11 and the light projecting lens 13 are fixed to the optical base 50, displacement and slight shifting of the optical axis hardly occur.

The optical path length adjustment mechanism 30 is fixed to the optical base 50 in a state where the optical path length conversion element 12a of the conversion element holder 12 is arranged on the optical path of the detection light L1. The trimmer operation section 31 includes a pedestal head 31a and a shaft section 31b, and the shaft section 31b is coupled to the coupling member 34 with the pedestal head 31a exposed from the body case 40.

FIG. 10 is a diagram showing one example of the operation of the distance measuring photoelectric sensor 1 in FIG. 2, showing a state where a spot diameter distribution changes by adjusting the optical path length of the detection light L1. FIG. 10 shows four spot diameter distributions TS1 to TS4 for different thicknesses of the optical path length conversion element 12a from each other, with a horizontal axis taken as the distance from the distance measuring photoelectric sensor 1 and a vertical axis taken as the spot diameter of the light projection spot.

The spot diameter distributions TS1 to TS4 represent beam diameters of the detection light L1 in respective positions spaced from the distance measuring photoelectric sensor 1 in a direction of a light projection axis. The spot diameter distributions TS1 and TS2 are distribution curves in the case where the detection light L1 is formed of converging light, and as it is farther from the distance measuring photoelectric sensor 1, the spot diameters monotonously decrease from a value S₁, and become minimal respectively at focus positions FP₁, FP₂.

The spot diameter distribution TS3 is a distribution curve in the case where the detection light L1 is formed of parallel light, and the spot diameter is the constant value S₁ regardless of the distance from the distance measuring photoelectric sensor 1. The spot diameter distribution TS4 is a distribution curve in the case where the detection light L1 is formed of diffusion light, and as it is farther from the distance measuring photoelectric sensor 1, the spot diameter monotonously increases from the value S₁. By adjusting the optical path length of the detection light L1 in such a manner, it is possible to increase or reduce the spot diameter at a predetermined distance, or to move the focus position FP in the direction of the light projection axis.

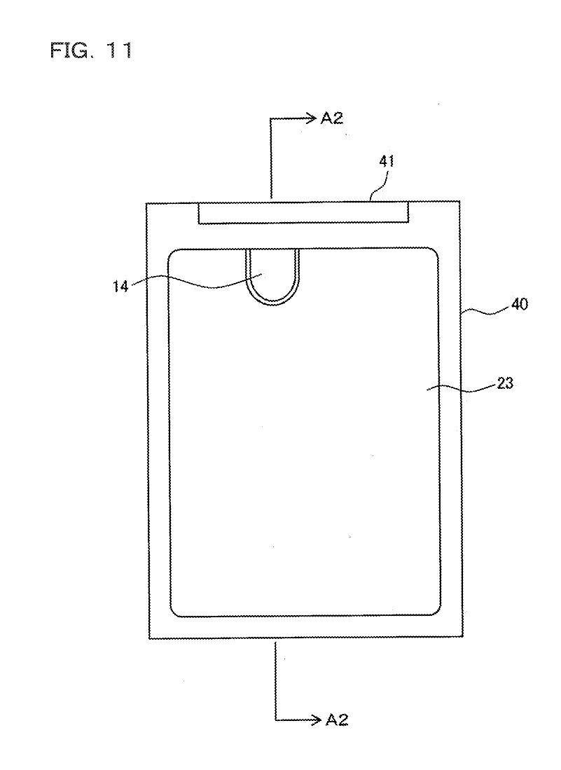

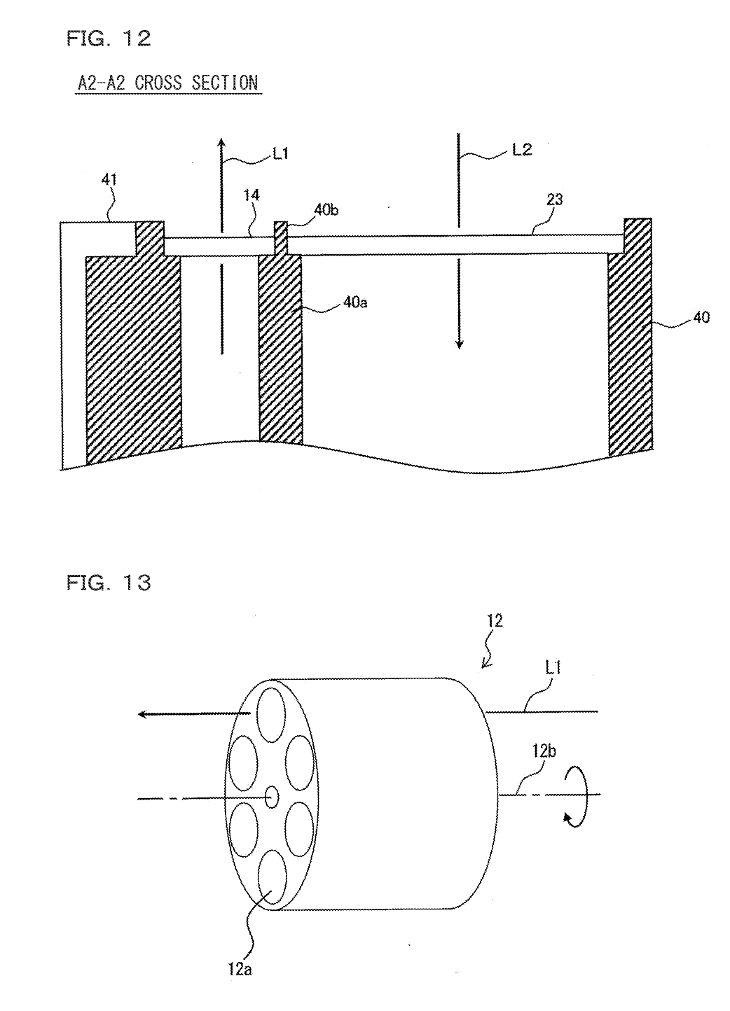

FIG. 11 is a view showing a configuration example of the distance measuring photoelectric sensor 1 in FIGS. 1A and 1B, showing a light projecting/receiving surface of the body case 40. Further, FIG. 12 is a cross-sectional view showing a configuration example of the distance measuring photoelectric sensor 1 in FIG. 11, showing a section in the case where the body case 40 is cut along a cutting line A2-A2. The light projecting/receiving surface of the body case 40 is configured by the light projecting lens cover 14 that covers a light projecting opening formed on the front surface of the body case 40, and the light receiving lens cover 23 that covers a light receiving opening formed on the front surface of the body case 40. Most of the periphery of a light projecting area formed of the light projecting lens cover 14 is adjacent to a light receiving area.

The light projecting lens cover 14 and the light receiving lens cover 23 respectively seal the light projecting opening and the light receiving opening. The body case 40 is provided with a partition 40a that separates a light projecting space where the optical path of the detection light L1 is formed and a light receiving space where the optical path of the reflected light L2 is formed, and one end 40b of the partition 40a is exposed to the external space.

The one end 40b projects more than the light projecting lens cover 14 and the light receiving lens cover 23. By providing such one end 40b on the partition 40a, it is possible to prevent part of the detection light L1 reflected by the surface of the light projecting lens cover 14 or by a foreign matter adhered to the light projecting lens cover 14 from being incident in the light receiving space and becoming disturbance light.

According to the present embodiment, by adjusting the optical path length of the detection light L1 from the light emitting element 11 to the light projecting lens 13 without changing an actual distance between the light emitting element 11 and the light projecting lens 13, the apparent position of the light emitting element 11 in the case of being seen from the emission side of the light projecting lens 13 moves in the direction of the optical axis, and hence it is possible to freely change the size of the spot diameter of the detection light L1 in the detection region.

Further, since the movable mechanism that physically moves the light emitting element 11 or the light projecting lens 13 is not required, displacement of the optical axis between the light emitting element 11 and the light projecting lens 13 hardly occurs. Moreover, in the case where the detection light L1 passes through the optical path length conversion element 12a which has the incident surface NM and the emitting surface SM parallel to each other, even if the position or the direction of the optical path length conversion element 12a is slightly displaced, it has a small influence on the optical path length. Hence, a mechanical load such as a vibration or a change in ambient temperature hardly has an influence, and it is thus possible to accurately control the size of the spot diameter.

Further, since the optical path length is adjusted by selectively arranging the optical path length conversion element 12a between the light emitting element 11 and the light projecting lens 13, it is possible to suppress an increase in size of the distance measuring photoelectric sensor 1 in the direction of the light projection axis. Moreover, since the optical path length conversion element 12a need not be held by a rigid structure, it is possible to suppress an increase in size of the device and a rise in manufacturing cost.

With the light emitting element 11 and the light projecting lens 13 fixed to the optical base 50, the mounting structure for these optical members can be reduced in size and simplified. Moreover, the optical path length conversion element 12a has the light transmitting region with a shape and a size capable of sufficiently covering the optical path of the detection light L1. Therefore, even if the position or the direction of the optical path length conversion element 12a is displaced due to an influence of play in a stopper mechanism configured by the coupling member 34 and the engagement section 33b of the rotating shaft support member 33, or of a vibration transmitted from the trimmer operation section 31, the size of the light projection spot remains unchanged and is hardly influenced by an ambient environment.

### Second Embodiment

In the first embodiment, the description has been given of the example of the case where the conversion element holder is provided with the plurality of optical path length conversion elements 12a each having a different distance between the incident surface NM and the emitting surface SM. In contrast, in the present embodiment, a description will be given of a case where the conversion element holder 12 is provided with two or more optical path length conversion elements 12a each having a different refractive index n.

FIG. 13 is a perspective view showing one configuration example of the distance measuring photoelectric sensor 1 according to a second embodiment of the present invention, showing the conversion element holder 12 including two or more optical path length conversion elements 12a each having a different refractive index n from each other. FIG. 13 shows the conversion element holder 12 including six optical path length conversion elements 12a and capable of adjusting the optical path length in six stages.

Each optical path length conversion element 12a has the incident surface and the emitting surface vertical to the optical axis KJ of the light emitting element 11, and is made of a transparent member having a different refractive index n from each other. The distance between the incident surface and the emitting surface in each optical path length conversion element 12a is the same. This conversion element holder 12 has the rotating shaft 12b parallel to the optical axis KJ, and holds the optical path length conversion elements 12a in different positions in the circumferential direction around the rotating shaft 12b.

For example, by adjusting a content of an additive, it is possible to obtain a transparent member with a different refractive index n. Further, by selecting the rotating angle of the conversion element holder 12 around the rotating shaft 12b, it is possible to arrange any one of the optical path length conversion elements 12a on the optical path of the detection light L1.

In the first embodiment, the description has been given of the example of the case where the rotating angle of the conversion element holder 12 is selected so that any one of the eight optical path length conversion elements 12a is arranged on the optical path of the detection light L1, but in the present invention, the configuration of the conversion element holder 12 is not limited thereto. For example, whether or not one optical path length conversion element 12a is arranged on the optical path of the detection light L1 may be selectable, and the optical path length may be adjusted based on whether or not the optical path length conversion element 12a is arranged on the optical path of the detection light L1. Alternatively, a notch region without the optical path length conversion element 12a may be formed in the conversion element holder 12, and this notch region can be arranged on the optical path of the detection light L1.

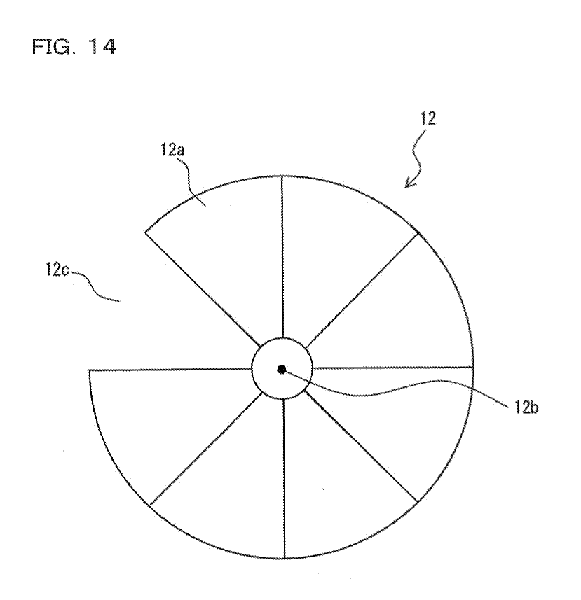

FIG. 14 is a view showing another configuration example of the distance measuring photoelectric sensor 1 in FIG. 2, showing a conversion element holder 12 capable of selecting a notch region 12C without the optical path length conversion element 12a. In this conversion element holder 12, when compared to the conversion element holder 12 in FIG. 3, one of fan-shaped regions around the rotating shaft 12b is the notch region 12c.

By selecting the rotating angle of the conversion element holder 12, any one of the seven optical path length conversion elements 12a and the notch region 12c can be arranged on the optical path of the detection light L1, and the optical path length can be adjusted in eight stages.

Further, in the first embodiment, the description has been given of the example of the case where the rotating angle of the conversion element holder 12 around the rotating shaft 12b is selected so that any one of the optical path length conversion elements 12a is arranged on the optical path of the detection light L1, but in the present invention, the configuration of the optical path length adjustment mechanism 30 is not limited thereto. For example, the conversion element holder 12 holds two or more optical path length conversion elements 12a arranged on a straight line in the state of facing the same direction. By linearly moving this conversion element holder 12 toward a direction intersecting with the optical axis KJ of the light emitting element 11, any one of the optical path length conversion elements 12a may be arranged on the optical path of the detection light L1.

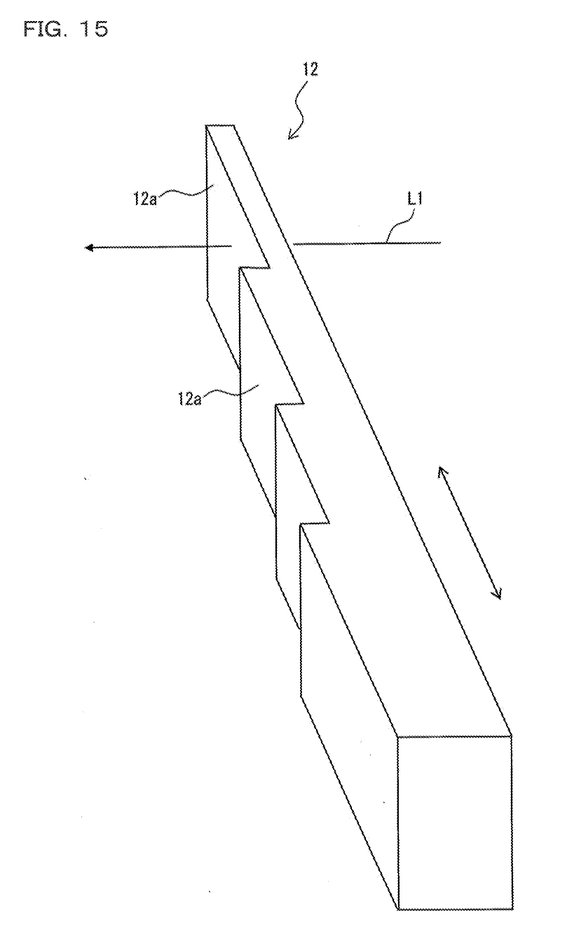

FIG. 15 is a perspective view showing another configuration example of the distance measuring photoelectric sensor 1, showing the conversion element holder 12 that is linearly moved in a direction intersecting with the optical axis KJ of the light emitting element 11. FIG. 15 shows the conversion element holder 12 including four optical path length conversion elements 12a each having a different thickness and capable of adjusting the optical path length in four stages. This conversion element holder 12 is made of a plate body provided with steps in a linear staircase shape on its surface on the light projecting lens side.

Each optical path length conversion element 12a has a rectangular-shaped light transmitting region. Further, the optical path length conversion element 12a and the conversion element holder 12 are integrally formed using a transparent material. By moving the conversion element holder 12 in a sliding direction vertical to the optical axis KJ and selecting a position in the sliding direction, it is possible to arrange any one of the optical path length conversion elements 12a on the optical path of the detection light L1. Further, by also making the region without the optical path length conversion element 12a selectable, it is possible to adjust the optical path length in five stages.

Moreover, in the first embodiment, the description has been given of the example of the case where the rotating angle of the conversion element holder 12 around the rotating shaft 12b parallel to the optical axis KJ is selected so that any one of the optical path length conversion elements 12a is arranged on the optical path of the detection light L1, but in the present invention, the configuration of the optical path length conversion element 12a is not limited thereto. For example, the optical path length conversion element 12a may be configured such that the distance between the incident surface and the emitting surface changes in accordance with the rotating angle.

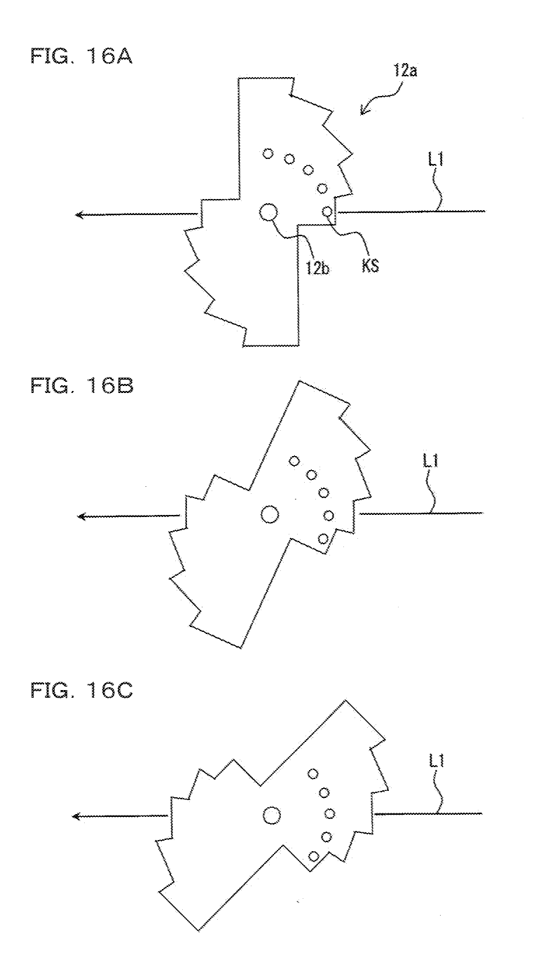

FIGS. 16A to 16C are views showing another configuration example of the distance measuring photoelectric sensor 1, and FIGS. 16A to 16C show the optical path length conversion element 12a in which a distance between the incident surface and the emitting surface changes in stages in accordance with a rotating angle. FIGS. 16A to 16C show the optical path length conversion element 12a capable of adjusting the optical path length in five stages. This optical path length conversion element 12a has the rotating shaft 12b vertical to the optical axis KJ of the light emitting element 11, and is made of a parallel plate provided with steps in a staircase shape on its circumferential surface around the rotating shaft 12b vertical to the plate surface.

In the optical path length conversion element 12a, the distance between the incident surface and the emitting surface changes in stages in accordance with the rotating angle around the rotating shaft 12b. In this example, a stopper section KS for stopping rotation is provided in the optical path length conversion element 12a. The stopper section KS is an engagement section for selecting the rotating angle of the optical path length conversion element 12a around the rotating shaft 12b, and has a projected shape or a recessed shape. The rotating angle of the optical path length conversion element 12a is selected by the stopper section KS as described above, to thereby allow adjustment of the optical path length.

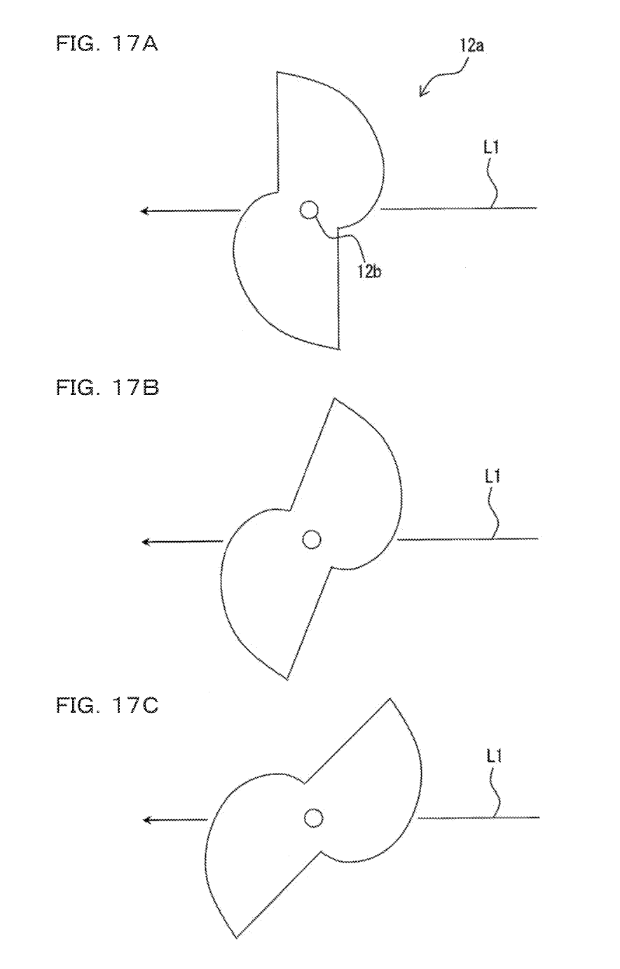

FIGS. 17A to 17C are views showing another configuration example of the distance measuring photoelectric sensor 1, and FIGS. 17A to 17C show the optical path length conversion element 12a in which a distance between the incident surface and the emitting surface changes continuously in accordance with a rotating angle. This optical path length conversion element 12a has the rotating shaft 12b vertical to the optical axis KJ of the light emitting element 11, and is made of a parallel plate having a shape whose size in a diameter direction around the rotating shaft 12b vertical to the plate surface monotonously increases.

In the optical path length conversion element 12a, the distance between the incident surface and the emitting surface changes continuously in accordance with the rotating angle around the rotating shaft 12b. Even with such a configuration, the size of the spot diameter of the detection light L1 can be freely changed while being hardly affected by an ambient environment.

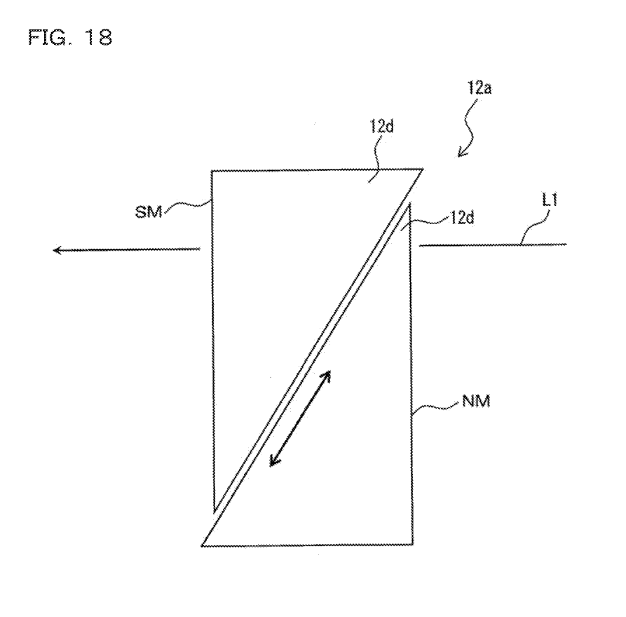

FIG. 18 is a view showing another configuration example of the distance measuring photoelectric sensor 1, showing the optical path length conversion element 12a formed of two wedge-shaped optical members 12d which are arranged with the inclined surfaces opposed to each other. One optical member 12d is arranged on the light emitting element 11 side, and is made of a transparent member having the incident surface NM orthogonal to the optical axis KJ and the inclined surface inclined with respect to the optical axis KJ. The other optical member 12d is arranged on the light projecting lens 13 side, and is made of a transparent member having the emitting surface SM orthogonal to the optical axis KJ and the inclined surface inclined with respect to the optical axis KJ.

For example, the optical member 12d on the light projecting lens side is fixed to the optical base 50, and the optical member 12d on the light emitting element side is held movably in an inclined direction. By moving the optical member 12d on the light emitting element side in the inclined direction, the distance between the incident surface NM and the emitting surface SM continuously changes, to thereby allow seamless adjustment of the optical path length.

In the first and second embodiments, the description has been given of the example of the case where the optical path length conversion element 12a is selectively arranged between the light emitting element 11 and the light projecting lens 13 so that the optical path length of the detection light L1 from the light emitting element 11 to the light projecting lens 13 is adjusted, but in the present invention, the optical path length adjustment method for adjusting the size of the spot diameter of the detection light L1 to be used for measurement of the distance is not limited thereto. For example, the light emitting element 11 or the light projecting lens 13 may be moved in the direction of the optical axis to change the distance between the light emitting element 11 and the light projecting lens 13, to thereby adjust the optical path length of the detection light L1 from the light emitting element 11 to the light projecting lens 13.

What is claimed is:

1. A distance measuring photoelectric sensor comprising:
a light emitting element which generates detection light;
a light projecting lens which is arranged on an optical axis of the light emitting element and is configured to project the detection light toward a detection region;
an optical path length adjustment mechanism which adjusts an optical path length of the detection light from the light emitting element to the light projecting lens;
a light receiving element which receives the detection light reflected from a detection target section in the detection region, and generates a light receiving signal; and
a distance computing section which measures a distance to the detection target from transmission time of the detection light based on the light receiving signal,
wherein a size of a spot diameter of the detection light to be used for measurement of the distance is freely selectable by the optical path length adjustment mechanism.

2. The distance measuring photoelectric sensor according to claim 1, wherein the optical path length adjustment mechanism selectively arranges an optical path length conversion element having an incident surface and an emitting surface parallel to each other between the light emitting element and the light projecting lens, to adjust the optical path length.

3. The distance measuring photoelectric sensor according to claim 1, wherein the optical path length adjustment mechanism switches in stages the size of the spot diameter of the detection light to be used for measurement of the distance.

4. The distance measuring photoelectric sensor according to claim 1, comprising a determination signal generation section which compares the distance with a previously set threshold, and generates a determination signal based on a result of the comparison.

5. The distance measuring photoelectric sensor according to claim 2, comprising:
two or more of the optical path length conversion elements each having a different distance between the incident surface and the emitting surface from each other,
wherein the optical path length adjustment mechanism selectively arranges any one of the optical path length conversion elements on the optical axis of the light emitting element.

6. The distance measuring photoelectric sensor according to claim 2, comprising
two or more of the optical path length conversion elements which are made of transparent members each having a different refractive index from each other,
wherein the optical path length adjustment mechanism selectively arranges any one of the optical path length conversion elements on the optical axis of the light emitting element.

7. The distance measuring photoelectric sensor according to claim 5, comprising
a conversion element holder which holds two or more of the optical path length conversion elements in different positions in a circumferential direction around a rotating shaft,
wherein the optical path length adjustment mechanism selects a rotating angle of the conversion element holder around the rotating shaft, to arrange any one of the optical path length conversion elements on the optical axis of the light emitting element.

8. The distance measuring photoelectric sensor according to claim 7, wherein the conversion element holder has a rotating shaft which is substantially parallel to the optical axis of the light emitting element.

9. A method for controlling a light projection spot of a distance measuring photoelectric sensor which projects detection light toward a detection region and receives the detection light reflected from a detection target in the detection region,
wherein an optical path length conversion element which has an incident surface and an emitting surface parallel to each other is selectively arranged on an optical path of the detection light from a light emitting element which generates the detection light to a light projecting lens, to adjust a length of the optical path.
